(19) United States
(12) Patent Application Publication
(10) Pub. No.: US 2020/0042868 A1
(43) Pub. Date: Feb. 6, 2020

(54) METHOD AND APPARATUS FOR DESIGNING FLEXIBLE DATAFLOW PROCESSOR FOR ARTIFICIAL INTELLIGENT DEVICES

(71) Applicant: Nanjing Iluvatar CoreX Technology Co., Ltd. (DBA Iluvatar CoreX Inc. Nanjing), Nanjing (CN)

(72) Inventors: Pingping Shao, San Jose, CA (US); Yile Sun, Shanghai (CN); Ching-En Lee, San Jose, CA (US); Jinshan Zheng, Shanghai (CN); Yunxiao Zou, Shanghai (CN)

(73) Assignee: Nanjing Iluvatar CoreX Technology Co., Ltd. (DBA Iluvatar CoreX Inc. Nanjing), Nanjing (CN)

(21) Appl. No.: 16/237,617

(22) Filed: Dec. 31, 2018

(30) Foreign Application Priority Data
Aug. 1, 2018 (CN) 201810862229.4

(51) Int. Cl. G06N 3/063; G06N 3/08; G06N 3/04

(52) U.S. Cl. CPC G06N 3/063; G06N 3/04; G06N 3/08

(57) ABSTRACT

The present invention is a flexible data stream processor and processing method for an artificial intelligence device, including a frontal engine, a parietal engine group, an occipital engine, and a temporal engine; capable of dividing a tensor into a plurality of tile blocks, and then each Tile blocks are divided into several tiles, each tile is divided into several wave blocks, each wave block is divided into several waves, and waves with the same rendering features are processed in the same neuron block; AI work can be distributed across multiple parietal engines for parallel processing and weight reuse, activation reuse, weight station reuse, partial and reuse.

### CROSS-REFERENCE TO RELATED APPLICATION

This US nonprovisional patent application claims priority to a Chinese invention application serial number 201810862229.4, filed on Aug. 1, 2018, whose disclosure is incorporated by reference in its entirety herein.

### TECHNICAL FIELD

Embodiments of the invention generally relate to the field of artificial intelligence technology, in particular to a flexible data stream processor and a processing method for an artificial intelligence device.

### BACKGROUND

Artificial intelligence (AI) processing has been a popular topic recently, both in terms of computationally and memory intensive, as well as high performance-power efficiency. Accelerating computing with current devices such as CPUs and GPUs is not easy, and many solutions such as GPU+TensorCore, tensor processing unit (TPU), central processing unit (CPU)+field programmable gate array (FPGA), and AI application-specific integrated circuit (ASIC) has been proposed to address these problems. GPU+TensorCore tends to focus on solving computationally intensive problems, while TPU tends to focus on computation and data reuse issues, and CPU+FPGA/AI ASICs focus on improving performance-power efficiency.

Artificial intelligence feature maps can usually be described as four-dimensional tensors [N, C, Y, X]. The four dimensions are: feature graph dimensions: X, Y; channel dimension: C; batch dimension: N. The kernel can be a four-dimensional tensor [K, C, S, R]. The AI job is to give the input feature map tensor and kernel tensor. Other operations, such as normalization and activation, are also possible. These can be supported in a general purpose hardware operator. Therefore, there is a need for a better hardware architecture and data processing method to process data streams more flexibly and efficiently.

### SUMMARY

The technical problem to be solved by the present invention is to provide a flexible data stream processor and processing method for an artificial intelligence device.

In order to solve the above technical problems, the technical solution adopted by the present invention is:

A flexible data stream processor for an artificial intelligence device, comprising: a frontal engine, a parietal engine group, an occipital engine, and a temporal engine;

The frontal engine is provided with a tile block scheduler, the frontal engine receives the tensor information, the tile scheduler divides the tensor into a plurality of tile blocks, and the frontal engine allocates the tile block to the parietal engine group;

The parietal engine group includes a plurality of parietal engines, and a tile dispatcher and a wave block scheduler are disposed in the parietal engine, and the tile dispatcher obtains the tile block and divides the tile into a plurality of tiles. The wave block scheduler acquires the tile and divides it into several wave blocks;

The parietal engine is further provided with a plurality of flow sensor processors, and the flow sensor processor is provided with a wave block dispatcher, and the wave block dispatcher can divide the wave block into several waves, and the flow sensor processor further A neuron station is provided, and the neuron station is composed of a plurality of neuron blocks, and the waves are characterized in the neuron block;

The occipital engine receives and organizes the rendered partial tensor and outputs it;

The temporal engine receives the tensor information output by the occipital engine, performs post processing and writes the final tensor into the memory.

In order to optimize the above utility models, specific measures taken include:

One tensor of the tensor information has 5 dimensions, including feature map dimensions: X, Y; channel dimensions C, K, where C represents an input feature map, K represents an output feature map, and N represents a batch dimension.

The structure of the pillow-shaped engine is a unified rendering architecture, and specifically includes: the rendering feature is sent back to the parietal engine, and after the parietal engine finishes rendering, the result is sent back to the occipital engine.

The frontal engine sends the group tensor to the parietal engine in a polling schedule, and all the stream perceptron processors share an L2 cache and an export block.

The neuron blocks within the stream perceptron processor have a set of multiply accumulators, each of which can process information having the same characteristics.

A flexible data stream processing method for an artificial intelligence device, characterized in that a tensor has five dimensions, including a feature map dimension: X, Y; a channel dimension C, K, where C represents an input feature map and K represents an output feature. Mapping; N stands for batch dimension; divides the tensor into several tile blocks, divides each tile block into several tiles, divides each tile into several wave blocks, and divides each wave block into two Several waves, and the waves with the same rendering characteristics are processed in the same neuron block; The specific steps are as follows:

Step 1. The block tile scheduler in the frontal engine receives the tensor information from the application through the driver. According to the requirements of the application, the tile scheduler divides the tensor into a plurality of tile blocks, and the tile blocks are polled. The scheduling mode is assigned to the parietal engine group;

Step 2, the tile tile dispatcher in the parietal engine acquires the tile block and divides the tile block of the α dimension to form a plurality of tiles, wherein the α dimension is an N or C or K dimension;

Step 3: The block wave scheduler in the parietal engine acquires the tile and divides the X and Y dimensions to form a plurality of wave blocks, and the wave block is sent to the flow sensor processor in the parietal engine;

Step 4: The block wave dispatcher in the flow sensor processor acquires the wave block and divides it into a plurality of waves based on the β dimension, wherein the β dimension is an N or C or K dimension;

Step 5, the neuron station in the flow sensor processor loads the activation and weight, and performs neuron processing;

In step 6, there is a multiply accumulator set in the neuron block in the neuron station, and each multiply accumulator set processes waves having the same beta dimension.

In step 1, the tile scheduler divides the tensor into the same number of tile blocks as the parietal engine in the parietal engine group.

The size of tiles, tiles, blocks and waves is programmable.

The flexible data stream processor and processing method for artificial intelligence devices can achieve the beneficial effects that the artificial intelligence work is divided into many highly parallel parts, some parts are allocated to one engine for processing, and the number of engines is configurable. This increases scalability, and all work partitions and allocations are implemented in this architecture. With flexible control and data reuse, we can save power and achieve better performance for high performance.

In the process of reprocessing the data stream, these tasks are distributed in parallel to the computer kernel, and this distribution can be controlled by the user to reuse the AI feature map. Specifically, AI work can be distributed to multiple top-level engines for parallel processing, and implements weight reuse, activation reuse, weight station reuse, partial and reuse. There are some options in the data stream that can be used to obtain weight parallelism and activate parallelism.

### BRIEF DESCRIPTION OF THE DRAWINGS

In order to more clearly describe the technical schemes in the specific embodiments of the present application or in the prior art, hereinafter, the accompanying drawings required to be used in the description of the specific embodiments or the prior art will be briefly introduced. Apparently, the drawings described below show some of the embodiments of present application, and for those skilled in the art, without expenditure of creative labor, other drawings may be derived on the basis of these accompanying drawings.

FIG. 1 shows the engine flow chart.

FIG. 2 shows the engine level architecture diagram.

FIG. 3 is a flow chart of the data flow.

### DETAILED DESCRIPTION

Embodiments of the present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

The invention is further described below in conjunction with the drawings and particularly preferred embodiments.

A flexible data stream processor for an artificial intelligence device, comprising: a frontal engine, a parietal engine group, an occipital engine, and a temporal engine;

The frontal engine is provided with a tile block scheduler, the frontal engine receives the tensor information, the tile scheduler divides the tensor into a plurality of tile blocks, and the frontal engine allocates the tile block to the parietal engine group;

The parietal engine group includes a plurality of parietal engines, and a tile dispatcher and a wave block scheduler are disposed in the parietal engine, and the tile dispatcher obtains the tile block and divides the tile into a plurality of tiles. The wave block scheduler acquires the tile and divides it into several wave blocks;

The parietal engine is further provided with a plurality of flow sensor processors, and the flow sensor processor is provided with a wave block dispatcher, and the wave block dispatcher can divide the wave block into several waves, and the flow sensor processor further A neuron station is provided, and the neuron station is composed of a plurality of neuron blocks, and the waves are characterized in the neuron block;

The occipital engine receives and organizes the rendered partial tensor and outputs it;

The temporal engine receives the tensor information output by the occipital engine, performs post processing and writes the final tensor into the memory.

Further, one tensor of the tensor information has 5 dimensions, including feature map dimensions: X, Y; channel dimensions C, K, where C represents an input feature map, K represents an output feature map, and N represents a batch dimension.

Further, the structure of the occipital engine is a unified rendering architecture, which includes: the rendering feature is sent back to the parietal engine, and after the parietal engine finishes rendering, the result is sent back to the occipital engine.

Further, the frontal engine sends the group tensor to the parietal engine in a polling schedule, and all the stream perceptron processors share an L2 cache and a derived block.

Further, the neuron blocks within the stream perceptron processor have a set of multiply accumulators, each of which can process information having the same characteristics.

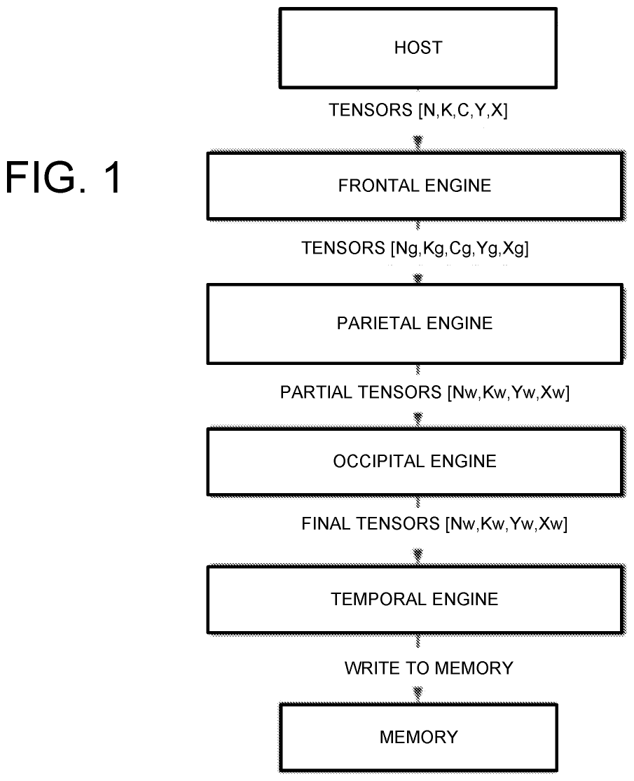

In this embodiment, as shown in FIG. 1, the artificial intelligence work can be regarded as a 5-dimensional tensor [N, K, C, Y, X]. In each dimension, we divide the work into groups, each of which may be further divided into waves. In our architecture, the first engine, the Frontal Engine (FE), gets 5D tensors [N, K, C, Y, X] from the host and divides it into many sets of tensors [Ng, Kg, Cg, Yg, Xg], and send these groups to the Parietal Engine (PE). The PE obtains the group tensor and divides it into waves, sends the waves to the renderer engine to execute the input feature renderer (IF-Shader), and outputs partial tensors (Nw, Kw, Yw, Xw) to the pillow. Occipital Engine (OE). The OE accumulates a partial tensor and executes an output feature renderer (OF-Shader) to obtain the final tensor sent to the next engine, the Temporal Engine (TE). TE performs some data compression and writes the final tensor into memory.

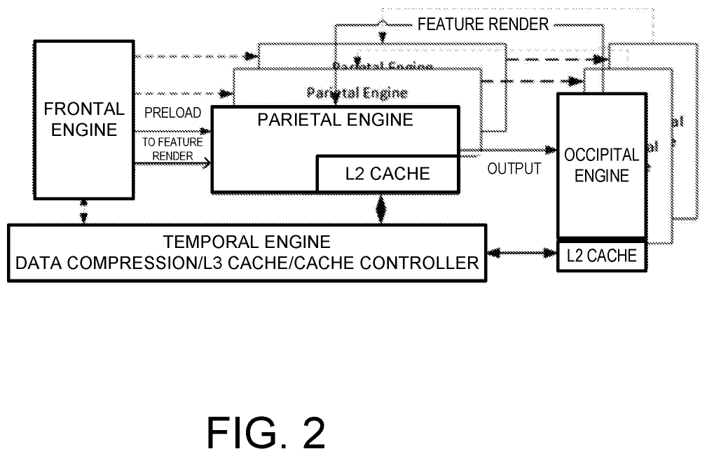

In this embodiment, as shown in FIG. 2, in the front-end engine (FE), the tensors are divided into groups, and these groups are sent to the Parietal Engine (PE). Each parietal engine processes the groups according to a user-defined input feature renderer (IF-Shader) and outputs the partial sum to the Occipital Engine (OE). The OE collects the output tensor and dispatches an output feature renderer to further process the tensor.

There are two ways to handle the Output Feature Renderer (OF-Shader). In the unified rendering architecture, the output feature renderer is sent back to the parietal engine, and once the parietal engine finishes rendering, it sends the result back to OE. In the split rendering architecture, the output feature renderer is processed in the OE. The OE results send the output tensors to the Temporal Engine (TE), which performs some post processing and sends them to the DRAM or saves them in the cache for further processing.

As shown in FIG. 3, a flexible data stream processing method for an artificial intelligence device is characterized in that a tensor has five dimensions, including a feature map dimension: X, Y; a channel dimension C, K, where C represents an input feature. Mapping, K represents the output feature map; N represents the batch dimension; divides the tensor into several tile blocks, divides each tile block into several tiles, and divides each tile into several wave blocks, and then divides each tile into several wave blocks. Dividing each wave block into waves and processing the waves with the same rendering features in the same neuron block;

The specific steps are as follows:

Step 1. The block tile scheduler in the frontal engine receives the tensor information from the application through the driver. According to the requirements of the application, the tile scheduler divides the tensor into a plurality of tile blocks, and the tile blocks are polled. The scheduling mode is allocated to the parietal engine group; in this embodiment, the tensor is (N=32, K=128, C=64, Y=256, X=256), and the tile block is (N=4, K=8, C=16, Y=16, X=16). There are 8*16*4*16*16 tile blocks in total. These tile blocks are distributed in a polling schedule to the four parietal engines pre-set in our device.

Step 2: The tile tile dispatcher in the parietal engine acquires the tile block and divides the tile block of the alpha dimension to form a plurality of tiles, wherein the alpha dimension is an N or C or K dimension; in this embodiment, the tile The tile is (N=4, K=8, C=16, Y=16, X=16) is divided into four tiles in the C channel, each tile is (N=4, K=8), C=4, Y=16, X=16).

Step 3: The block wave scheduler in the parietal engine acquires the tile and divides the X and Y dimensions to form a plurality of wave blocks, and the wave block is sent to the flow sensor processor in the parietal engine. In this embodiment, The wave block is (N=4, K=8, C=4, Y=4, X=4). The wave scheduler creates 16 wave blocks. The wave blocks are sent to the pre-configured two sets of stream perceptron processors in the parietal engine.

Step 4: The block wave dispatcher in the flow sensor processor acquires the wave block and divides it into a plurality of waves based on the β dimension, wherein the β dimension is N or C or K dimension; in this embodiment, the wave is (N=1, K=8, C=1, Y=4, X=4). There are 16 waves that are sent to the NR (neurons) for processing.

Step 5, the neuron station in the flow sensor processor loads the activation and weight, and performs neuron processing;

In step 6, there is a multiply accumulator set in the neuron block in the neuron station, and each multiply accumulator set processes waves having the same beta dimension. In this embodiment, there are 8 multiply accumulator groups in each neuron block, and 8 Ks in the wave are mapped to 8 multiply accumulator groups, and each multiply accumulator group processes different K (weight), but the same X and Y (activated), which means activation is reused. The four neurons share the same 8 K, which means weight reuse. In the N dimension, the four feature maps share the same weight in the neurons, which means that the weight station reuses. In the C dimension, four different channels are processed in the same neuron, which means partial and reuse.

The size of the tiles, tiles, blocks, and waves are programmable so that the application can choose the configuration for optimal performance.

The above is only a preferred embodiment of the present invention, and the scope of protection of the present invention is not limited to the above embodiments, and all the technical solutions under the inventive concept belong to the protection scope of the present invention. It should be noted that a number of improvements and modifications without departing from the principles of the invention are considered to be within the scope of the invention.

Apparently, the aforementioned embodiments are merely examples illustrated for clearly describing the present application, rather than limiting the implementation ways thereof. For a person skilled in the art, various changes and modifications in other different forms may be made on the basis of the aforementioned description. It is unnecessary and impossible to exhaustively list all the implementation ways herein. However, any obvious changes or modifications derived from the aforementioned description are intended to be embraced within the protection scope of the present application.

The example embodiments may also provide at least one technical solution to a technical challenge. The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications, or modification of the disclosure.

In summary, the integrated circuit with a plurality of transistors, each of which may have a gate dielectric with properties independent of the gate dielectric for adjacent transistors provides for the ability to fabricate more complex circuits on a semiconductor substrate. The methods of fabricating such an integrated circuit structures further enhance the flexibility of integrated circuit design. Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

What is claimed is:

1. A flexible data stream processor for an artificial intelligence device, comprising: a frontal engine, a parietal engine group, an occipital engine, and a temporal engine;
The frontal engine is provided with a tile block scheduler, the frontal engine receives the tensor information, the tile scheduler divides the tensor into a plurality of tile blocks, and the frontal engine allocates the tile block to the parietal engine group;
the parietal engine group includes a plurality of parietal engines, and a tile dispatcher and a wave block scheduler are disposed in the parietal engine, and the tile dispatcher obtains the tile block and divides the tile into a plurality of tiles. The wave block scheduler acquires the tile and divides it into several wave blocks;
the parietal engine is further provided with a plurality of flow sensor processors, and the flow sensor processor is provided with a wave block dispatcher, and the wave block dispatcher can divide the wave block into several waves, and the flow sensor processor further A neuron station is provided, and the neuron station is composed of a plurality of neuron blocks, and the waves are characterized in the neuron block;
the occipital engine receives and organizes the rendered partial tensor and outputs it;
the temporal engine receives the tensor information output by the occipital engine, performs post processing and writes the final tensor into the memory.

2. The flexible data stream processor for an artificial intelligence device according to claim 1, wherein: one tensor of said tensor information has 5 dimensions, including feature map dimensions: X, Y; channel Dimensions C, K, where C represents the input feature map, K represents the output feature map; N represents the batch dimension.

3. The flexible data stream processor for an artificial intelligence device according to claim 2, wherein the occipital engine is constructed in a unified rendering architecture, and specifically includes: the rendering feature is sent back to the parietal engine. After the parietal engine finishes rendering, the results are sent back to the occipital engine.

4. The flexible data stream processor for an artificial intelligence device according to claim 1, wherein said frontal engine sends a group tensor to a parietal engine in a polling schedule, all streams The perceptron processor shares an L2 cache and an export block.

5. The flexible data stream processor for an artificial intelligence device according to claim 1, wherein said neuron block in said flow sensor processor has a multiply accumulator group, each multiply accumulator group Information with the same characteristics can be processed.

6. A flexible data stream processing method for an artificial intelligence device, characterized in that a tensor has five dimensions, including a feature map dimension: X, Y; a channel dimension C, K, where C represents an input feature map, and K represents Output feature map; N represents the batch dimension; divide the tensor into several tile blocks, divide each tile block into several tiles, divide each tile into several wave blocks, and then each wave The block is divided into waves and the waves with the same rendered features are processed in the same neuron block;
The specific steps are as follows:
Step 1. The block tile scheduler in the frontal engine receives the tensor information from the application through the driver. According to the requirements of the application, the tile scheduler divides the tensor into a plurality of tile blocks, and the tile blocks are polled. The scheduling mode is assigned to the parietal engine group;
Step 2, the tile dispatcher in the parietal engine acquires the tile block and divides the tile block of the α dimension to form a plurality of tiles, wherein the α dimension is an N or C or K dimension;
Step 3: The block wave scheduler in the parietal engine acquires the tile and divides the X and Y dimensions to form a plurality of wave blocks, and the wave block is sent to the flow sensor processor in the parietal engine;
Step 4: The block wave dispatcher in the flow sensor processor acquires the wave block and divides it into a plurality of waves based on the β dimension, wherein the β dimension is an N or C or K dimension;
Step 5, the neuron station in the flow sensor processor loads the activation and weight, and performs neuron processing;
In step 6, there is a multiply accumulator set in the neuron block in the neuron station, and each multiply accumulator set processes waves having the same beta dimension.

7. The flexible data stream processing method for an artificial intelligence device according to claim 6, wherein in step 1, the tile scheduler divides the number of tile blocks separated by the tensor from the parietal engine in the parietal engine group. The number of engines is the same.

8. A flexible data stream processing method for an artificial intelligence device according to claim 6 wherein the size of the tiles, tiles, blocks and waves is programmable.
